(19) United States
(12) Patent Application Publication
(10) Pub. No.: US 2010/0001969 A1
(43) Pub. Date: Jan. 7, 2010

(54) Display Device with Touch Panel

(75) Inventors: Teruaki SAITO, Mobara (JP); Hideo Sato, Hitachi (JP); Shigeyuki Nishitani, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/496,731

(22) Filed: Jul. 2, 2009

(30) Foreign Application Priority Data
Jul. 4, 2008 (JP) JP2008-175268

(51) Int. Cl. G06F 3/041

(52) U.S. Cl. 345/173

(57) ABSTRACT

In a display device with a touch panel which includes a display panel and a touch panel which is arranged to face the display panel in an opposed manner, the touch panel includes a transparent substrate, a plurality of first electrodes which is formed on a surface of the transparent substrate on a side facing the display panel, and a plurality of second electrodes which intersects with the plurality of first electrodes and is formed on the surface of the transparent substrate on the side facing the display panel, the display panel forms a planar third electrode which faces the plurality of first electrodes and the plurality of second electrodes on a surface thereof on a side facing the touch panel, and a distance between the plurality of first electrodes and the third electrode and a distance between the plurality of second electrodes and the third electrode are respectively set to 0.5 mm or less.

The present application claims priority from Japanese applications JP2008-175268 filed on Jul. 4, 2008, the content of which is hereby incorporated by reference into this application.

### BACKGROUND OF THE INVENTION

1. Field of the Invention

The present invention relates to a display device with a touch panel, and more particularly to a technique which is effectively applicable to a display device with a touch panel which includes an electrostatic-capacitance-coupling-type touch panel.

2. Description of the Related Art

Recently, a display device with a touch panel has been attracting attentions. As a touch panel technique used in such a display device, there has been known an electrostatic-capacitance-coupling-type touch panel. JP-T-2003-511799 (patent document 1) discloses a display device which detects a plurality of touch positions touched by a viewer using an electrostatic-capacitance-coupling-type touch panel.

The touch panel described in patent document 1 detects coordinates of a position touched by the viewer by detecting coupled capacitance of capacitance of an electrode in the X direction and capacitance of an electrode in the Y direction.

### SUMMARY OF THE INVENTION

An electrostatic-capacitance-coupling-type touch panel includes a plurality of X electrodes which extends in the first direction (for example, Y direction) and is arranged parallel to each other in the second direction (for example, X direction) which intersects with the first direction, and a plurality of Y electrodes which extends in the second direction while intersecting with the X electrodes and is arranged parallel to each other in the first direction. Such a touch panel is referred to as an X-Y type touch panel.

In the X-Y type touch panel, the plurality of X electrodes and the plurality of Y electrodes are stacked on a substrate with an interlayer insulation film sandwiched therebetween. These X electrodes and Y electrodes are formed using a transparent conductive material such as ITO (Indium Tin Oxide), for example.

On the other hand, there have been also known a method which inputs coordinates of a touch position by touching a touch face of a touch panel with a finger of a viewer (hereinafter simply referred to as a finger touch inputting method) and a method which inputs coordinates of a touch position by touching a touch face of a touch panel with a stylus pen (hereinafter simply referred to as a stylus pen inputting method).

However, in the stylus pen inputting method, a contact area between the touch face of the touch panel and the stylus pen is small compared to a contact area acquired by the finger touch inputting method. Accordingly, the stylus pen inputting method has a drawback that the recognition of the coordinate position is difficult.

The finger touch inputting method is a detection method which uses a finger as a conductive body. Accordingly, the conventional finger touch inputting method also has a drawback that the touch panel is not operated when a stylus pen (non-conductive body) touches the touch panel or a finger of a hand covered with a glove (non-conductive body) touches the touch panel.

The invention has been made to overcome the above-mentioned drawbacks of the related art, and it is an object of the invention to provide a highly reliable display device with a touch panel which can be operated by both of a finger touch inputting method and a stylus pen inputting method.

The above-mentioned and other objects and novel features of the invention will become apparent from the description of this specification and attached drawings.

To briefly explain the summary of typical inventions among the inventions disclosed in this specification, they are as follows.

(1) The invention is directed to a display device with a touch panel which includes: a display panel: and a touch panel which is arranged to face the display panel in an opposed manner, wherein the touch panel includes a transparent substrate, a plurality of first electrodes which is formed on a surface of the transparent substrate on a side facing the display panel, and a plurality of second electrodes which intersects with the plurality of first electrodes and is formed on the surface of the transparent substrate on the side facing the display panel, the display panel forms a planar third electrode which faces the plurality of first electrodes and the plurality of second electrodes on a surface thereof on a side facing the touch panel, and a distance between the plurality of first electrodes and the third electrode, and a distance between the plurality of second electrodes and the third electrode are respectively set to 0.5 mm or less.

(2) In the display device with a touch panel having the constitution (1), the touch panel may be adhered to the display panel by an adhesive agent.

(3) In the display device with a touch panel having the constitution (1), an air layer or an oil layer may be provided between the display panel and the touch panel.

(4) In the display device with a touch panel having the constitution (1), either one of the plurality of first electrodes and the plurality of second electrodes may be formed of a transparent conductive film.

(5) In the display device with a touch panel having the constitution (1), an insulation film may be formed between the plurality of first electrodes and the plurality of second electrodes.

(6) In the display device with a touch panel having the constitution (1), the third electrode may be formed of a transparent conductive film.

(7) In the display device with a touch panel having the constitution (1), the display panel may be a liquid crystal display panel, and the display panel includes a polarizer arranged on the third electrode.

(8) In the display device with a touch panel having the constitution (1), the display panel may be a liquid crystal display panel, and the touch panel has a polarizer which is arranged on a surface thereof on a side opposite to the display panel.

To briefly explain the advantageous effects acquired by typical inventions among the inventions disclosed in this specification, they are as follows.

According to the invention, it is possible to provide a highly reliable display device with a touch panel which can be operated by both of a finger touch inputting method and a stylus pen inputting method.

### BRIEF DESCRIPTION OF THE DRAWINGS

FIG. 1 is a plan view showing the schematic constitution of a display device with a touch panel of the invention;

FIG. 2 is a view showing an electrode pattern of the touch panel shown in FIG. 1;

FIG. 3 is a cross-sectional view showing the cross-sectional structure of an essential part of the touch panel shown in FIG. 1;

FIG. 4 is a view for explaining an operation principle of the touch panel of the invention;

FIG. 5 is a graph showing the relationship between the distance (h) shown in FIG. 4 and a capacitance value to ground (pF);

FIG. 6 is a graph for explaining an operation of detecting an input position of the touch panel of the invention; and

FIG. 7 is a plan view showing the schematic constitution of a modification of a display device with a touch panel of the invention.

### DESCRIPTION OF THE PREFERRED EMBODIMENTS

Hereinafter, an embodiment of the invention is explained in detail in conjunction with drawings. Here, in all drawings for explaining the embodiment of the invention, parts having identical functions are given same symbols, and their repeated explanation is omitted.

In this embodiment, the explanation is made with respect to a case in which a liquid crystal display panel is used as an example of a display panel. Here, the invention is applicable to any display panel which can mount a touch panel thereon. Further, the display panel is not limited to the liquid crystal display panel, and the display panel may be a display panel which uses organic light emitting diode elements, for example.

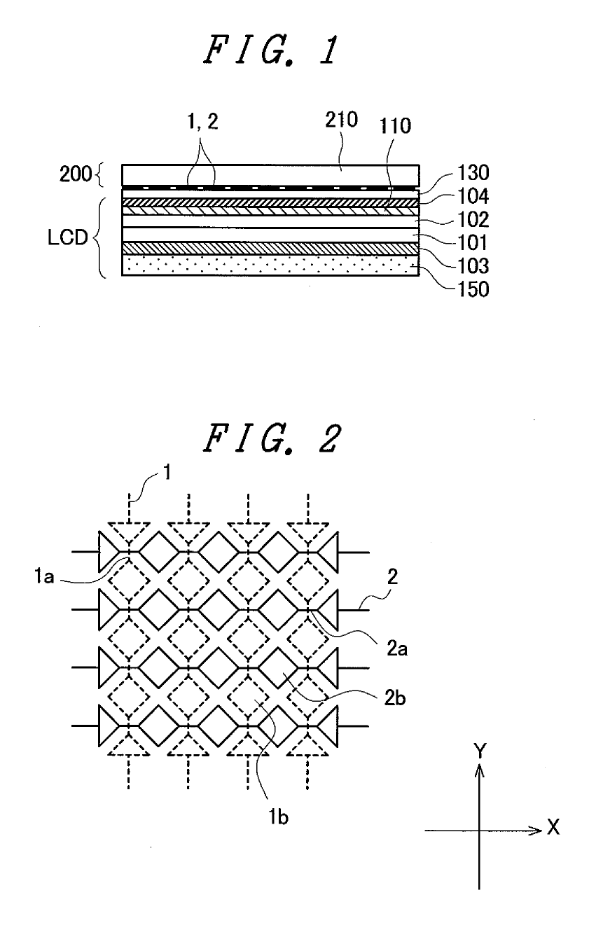

FIG. 1 is a plan view showing the schematic constitution of a display device with a touch panel according to the embodiment of the invention.

The display device with a touch panel of this embodiment includes, as shown in FIG. 1, a liquid crystal display panel (LCD) and an electrostatic-capacitance-coupling-type touch panel 200 which is arranged on a viewer's-side surface of the liquid crystal display panel (LCD). A backlight 150 which also constitutes a part of the liquid crystal display panel (LCD) is arranged on a lower-surface side of the liquid crystal display panel (LCD) opposite to a viewer's side. As the liquid crystal display panel (LCD), an IPS type liquid crystal display panel, a TN type liquid crystal display panel, a VA type liquid crystal display panel or the like can be used, for example.

The liquid crystal display panel (LCD) is constituted as follows, for example. A first substrate 101 which is formed of a glass substrate or the like and on which pixel electrodes, thin film transistors and the like are formed, and a second substrate 102 on which color filters and the like are formed overlapping with each other with a predetermined gap therebetween, both substrates are adhered to each other by a sealing material which is formed into a frame shape in the vicinity of peripheral portions of both substrates, liquid crystal is filled and sealed in a space defined inside the sealing material between both substrates through a liquid crystal filling port formed in a portion of the sealing material, and a polarizer (103, 104) is adhered to outer surfaces of both substrates.

Here, the invention is irrelevant to the inner structure of the liquid crystal display panel and hence, the detailed explanation of the inner structure of the liquid crystal display panel is omitted. Further, the invention is applicable to a liquid crystal display panel having any structure. For example, when the liquid crystal display panel is of a TN type or a VA type, counter electrodes are formed on the second substrate 102. When the liquid crystal display panel is of an IPS type, counter electrodes are formed on the first substrate 101.

The touch panel 200 of this embodiment includes X electrodes 1 and Y electrodes 2 which are formed on one surface (liquid-crystal-display-panel-(LCD)-side surface) of a transparent substrate 210 formed of a glass substrate or the like, for example. Here, with respect to the X electrodes 1 and the Y electrodes 2 which are arranged orthogonal to each other, the X electrodes 1 and the Y electrodes 2 are isolated from each other by an insulation film at least at intersecting portions of the X electrodes and the Y electrodes.

FIG. 2 shows an electrode pattern of the X electrodes 1 and the Y electrodes 2 of the touch panel 200 shown in FIG. 1.

The X electrodes 1 are formed of a transparent conductive film. In FIG. 2, the X electrodes 1 extend in the longitudinal direction (Y direction in the drawing), and are formed parallel to each other in the lateral direction (X direction). Further, the Y electrodes 2 extend in the lateral direction (X direction) in a state where the Y electrodes 2 intersect with the X electrodes 1, and are formed parallel to each other in the longitudinal direction (Y direction). The touch panel 200 of this embodiment detects a change of electrostatic capacitances of the X electrodes 1 and the Y electrodes 2, and calculates a position where the touch panel 200 is touched.

The respective X electrodes 1 and the respective Y electrodes 2 are formed as follows. Both of a width of the X electrode 1 and a width of the Y electrode 2 are made small at each intersecting portion 1a and each intersecting portion 2a where the X electrode 1 and the Y electrode 2 intersect with each other. A portion of the X electrode 1 which is sandwiched between the intersecting portions 1a form an electrode portion 1b having a large width, while a portion of the Y electrode 2 which is sandwiched between the intersecting portions 2a form an electrode portion 2b having a large width.

Each electrode portion 1b of the X electrode 1 is, as viewed in a plan view, arranged between two neighboring Y electrodes 2. Each electrode portion 2b of the Y electrode 2 is, as viewed in a plan view, arranged between two neighboring X electrodes 1.

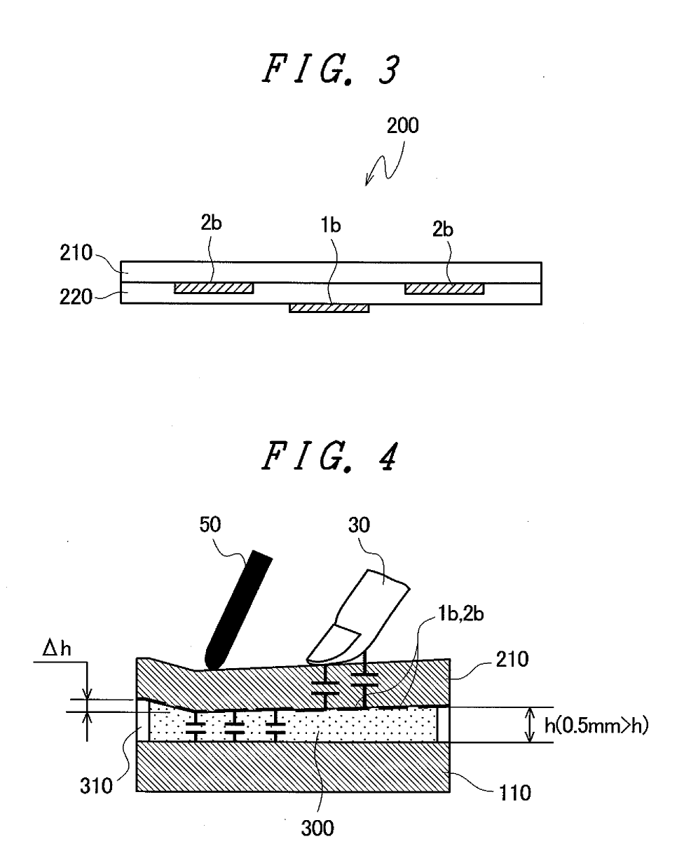

Here, the respective X electrodes 1 and the respective Y electrodes 2 are, as shown in FIG. 3, stacked on a surface of the transparent substrate 210 on a side facing the liquid crystal display panel (LCD) with the insulation film 220 sandwiched therebetween. In this embodiment, for example, the Y electrodes 2 are formed above the X electrodes 1 in terms of layer.

Returning to FIG. 1, the liquid crystal display panel (LCD) and the touch panel 200 are adhered to each other by an adhesive layer 130. The detail of the adhesive layer 130 is explained later.

A transparent conductive layer 110 is provided between the liquid crystal display panel (LCD) and the polarizer 104. Here, the respective X electrodes 1, the respective Y electrodes 2 and the transparent conductive layer 110 are formed using a transparent conductive material such as ITO (Indium Tin Oxide), for example.

Capacitances are formed between the transparent conductive layer 110 and the X electrodes 1 as well as between the transparent conductive layer 110 and the Y electrodes 2 (hereinafter such capacitances are referred to as capacitances to ground). The transparent conductive layer 110 also has a function of blocking signals generated from the liquid crystal display panel (LCD).

A large number of electrodes are formed on the liquid crystal display panel (LCD), and voltages are applied to the electrodes at various timings as signals.

With respect to the electrodes formed on the electrostatic-capacitance-coupling-type touch panel 200, that is, the X electrodes 1 and the Y electrodes 2, a change of the voltage which occurs in the liquid crystal display panel (LCD) causes noises. Due to the provision of the transparent conductive layer 110, it is possible to electrically shield the liquid crystal display panel (LCD). In this embodiment, to allow the transparent conductive layer 110 to function as a shield for electrically shielding the liquid crystal display panel (LCD), a constant voltage is applied to the transparent conductive layer 110. For example, a ground potential is supplied to the transparent conductive layer 110.

In the IPS type liquid crystal display panel, a back-side transparent conductive film is formed between the liquid crystal display panel (LCD) and the polarizer 104. The back-side transparent conductive film may be formed so as to function also as the transparent conductive layer 110.

FIG. 4 is a view for explaining an operation principle of the touch panel 200 of the invention. Here, in the drawing, the X electrodes 1 and the Y electrodes 2 are shown in a state where both electrodes 1, 2 are formed on the same layer. Further, a distance (h) between the X, Y electrodes 1, 2 and the transparent conductive layer 110 is held at an arbitrary value of 0.5 mm or less by a spacer 310.

Here, by filling air or oil in a space 300 defined between the X, Y electrodes 1, 2 and the transparent conductive layer 110, an air layer (or an oil layer) is formed so that the touch panel 200 deflects toward the transparent-conductive-layer-110 surface side when the touch panel 200 is pushed by a finger 30 or a stylus pen 50. By forming the oil layer in the space 300, the undesired reflection on the electrode pattern can be reduced due to the influence or the presence of oil and hence, the electrode pattern is hardly recognized leading to the enhancement of appearance quality.

The detailed structure of the adhesive layer 130 shown in FIG. 1 is already described. Here, the space 300 may be filled with an adhesive agent made of a material which can deflect toward the transparent-conductive-layer-110 surface side when the touch panel 200 is pushed by the finger 30 or the stylus pen 50.

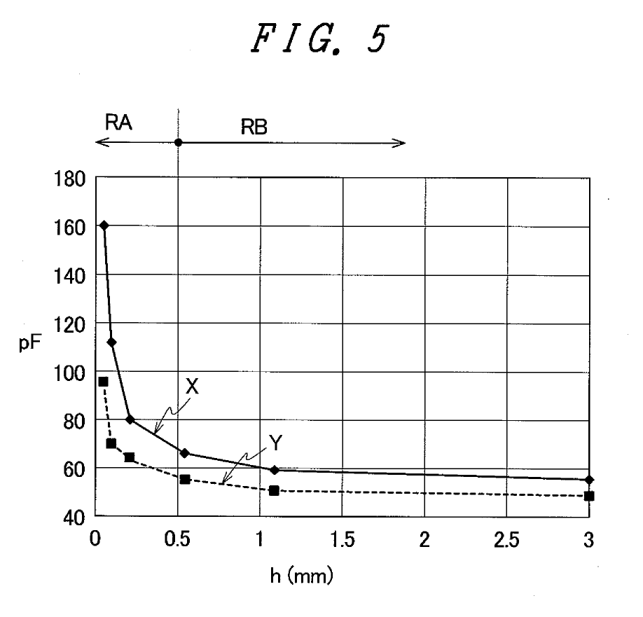

FIG. 5 is a graph showing the distance (h) shown in FIG. 4 and a change of capacitance value to ground (pF).

As can be understood from the graph of FIG. 5, in a region (region RB in FIG. 5) where the distance (h) between the X, Y electrodes 1, 2 and the transparent conductive layer 110 is larger than 0.5 mm, the capacitance value to ground (pF) is not changed, and the capacitance value to ground (pF) exhibits an inter-electrode capacitance value of the touch panel per se.

To the contrary, it is understood that, in a region of narrow distance (region RA in FIG. 5) where the distance (h) between the X, Y electrodes 1, 2 and the transparent conductive layer 110 is 0.5 mm or less, the capacitance value to ground (pF) is largely changed due to a minute change of gap (Ah in FIG. 4).

In this manner, according to this embodiment, the distance (h) between the X, Y electrodes 1, 2 and the transparent conductive layer 110 is set to the narrow distance of 0.5 mm or less so as to enable the detection of the touch position of the viewer based on the change of the capacitance value to ground generated by the minute deflection of the touch panel 200 when the viewer touches the touch panel 200. Accordingly, although a touch panel is not operated when a stylus pen (non-conductive body) touches a touch panel or a finger of a hand covered with a glove (non-conductive body) touches the touch panel in a conventional electrostatic capacitance coupling type touch panel, according to the invention, it is possible to detect a touch position of a viewer even when a touch on the touch panel is made using the stylus pen or the finger.

Further, the above-mentioned change of capacitance value is generated due to the minute deflection of the touch panel 200 when the viewer touches the touch panel and hence, it is possible to perform touch inputting using a finger of the viewer or a stick having a round distal end.

Still further, the presence or non-presence of touch is detected based on the change of capacitance value and hence, there is no contact between electrodes unlike the resistance-type touch panel and hence, it is possible to realize the highly reliable touch panel 200.

Hereinafter, a detection operation of an input position of the touch panel 200 according to this embodiment is simply explained.

In this embodiment, a constant current is sequentially supplied to the X electrodes 1 and the Y electrodes 2 from a touch panel control circuit (not shown in the drawing) so as to charge the X electrodes 1 or the Y electrodes 2. Then, a period (T) from a point of time that such charging of the constant current starts to a point of time that a voltage of the X electrodes 1 or a voltage of the Y electrodes 2 rises to a predetermined reference voltage (Vref) is measured.

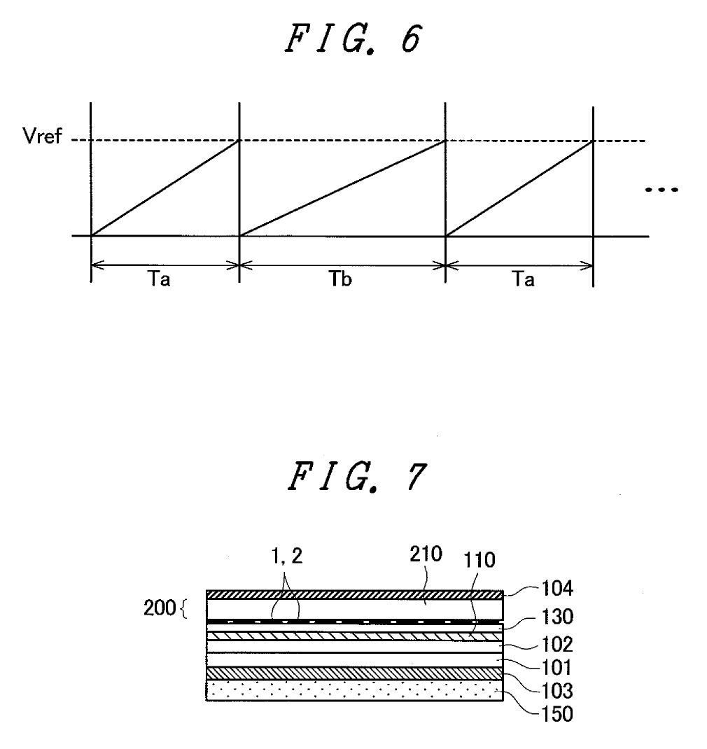

For example, as shown in FIG. 6, in a state where the viewer does not touch the touch panel 200 with his/her finger 30 or the like, the above-mentioned period (T) becomes Ta. On the other hand, in a state where the viewer pushes the touch panel 200 with his/her finger 30 or the stylus pen 50, as shown in FIG. 4 and FIG. 5, the capacitance to ground of the X electrodes 1 or the Y electrodes 2 is increased so that the above-mentioned period (T) becomes Tb which is longer than the period Ta (Ta<Tb).

Here, the above-mentioned period (T) may be detected, for example, by counting the number of reference clocks (for example, dot clocks (CLK) used in the liquid crystal display panel LCD).

FIG. 7 is a plan view showing the schematic constitution of a modification of the display device with a touch panel according to the embodiment of the invention.

The display device with a touch panel shown in FIG. 7 is characterized in that, in the display device with a touch panel shown in FIG. 1, the polarizer 104 arranged on the second substrate 102 is arranged on a viewer's-side surface of the transparent substrate 210 of the touch panel 200. The display device with a touch panel shown in FIG. 7 is equal to the display device with a touch panel shown in FIG. 1 with respect to constitutions other than the above-mentioned constitution and hence, their repeated explanation is omitted.

The display device with a touch panel shown in FIG. 7 can also acquire the manner of operation and advantageous effects substantially equal to the manner of operation and advantageous effects of the display device with a touch panel shown in FIG. 1.

As has been explained heretofore, according to this embodiment, the distance (h) between the X, Y electrodes 1, 2 and the transparent conductive layer 110 is set to the narrow distance of 0.5 mm or less so as to enable the detection of the touch position of the viewer based on the change of the capacitance value to ground generated by the minute deflection of the touch panel 200 when the viewer touches the touch panel 200. Accordingly, it is possible to detect a touch position of a viewer even when a touch on the touch panel is made using a stylus pen (non-conductive body) or a finger of a hand covered with a glove (non-conductive body).

Further, according to the display device with a touch panel of this embodiment, the X electrodes 1 and the Y electrodes 2 are formed on the liquid-crystal-display-panel-(LCD)-side surface of the transparent substrate 210 and hence, the formation of a scattering-prevention film or an acrylic cover on an uppermost portion of a touch panel which is necessary in a conventional touch panel can be eliminated. Accordingly, it is possible to realize the reduction of a thickness of the display device as well as the reduction of the number of parts.

Although the invention made by inventors of the invention has been specifically explained in conjunction with the embodiment heretofore, it is needless to say that the invention is not limited to the above-mentioned embodiment and various modifications are conceivable without departing from the gist of the invention.

What is claimed is:

1. A display device with a touch panel comprising:
a display panel: and
a touch panel which is arranged to face the display panel in an opposed manner, wherein
the touch panel includes a transparent substrate, a plurality of first electrodes which is formed on a surface of the transparent substrate on a side facing the display panel, and a plurality of second electrodes which intersects with the plurality of first electrodes and is formed on the surface of the transparent substrate on the side facing the display panel,
the display panel forms a planar third electrode which faces the plurality of first electrodes and the plurality of second electrodes on a surface thereof on a side facing the touch panel, and
a distance between the plurality of first electrodes and the third electrode and a distance between the plurality of second electrodes and the third electrode are respectively set to 0.5 mm or less.

2. A display device with a touch panel according to claim 1, wherein the touch panel is adhered to the display panel by an adhesive agent.

3. A display device with a touch panel according to claim 1, wherein an air layer or an oil layer is provided between the display panel and the touch panel.

4. A display device with a touch panel according to claim 1, wherein either one of the plurality of first electrodes and the plurality of second electrodes is formed of a transparent conductive film.

5. A display device with a touch panel according to claim 1, wherein an insulation film is formed between the plurality of first electrodes and the plurality of second electrodes.

6. A display device with a touch panel according to claim 1, wherein the third electrode is formed of a transparent conductive film.

7. A display device with a touch panel according to claim 1, wherein the display panel is a liquid crystal display panel, and the display panel includes a polarizer arranged on the third electrode.

8. A display device with a touch panel according to claim 1, wherein the display panel is a liquid crystal display panel, and the touch panel has a polarizer which is arranged on a surface thereof on a side opposite to the display panel.
